(19) United States
(12) Patent Application Publication
(10) Pub. No.: US 2004/0153671 A1
(43) Pub. Date: Aug. 5, 2004

(54) Automated physical access control systems and methods

(76) Inventors: Marc P. Schuyler, Mountain View, CA (US); Michael Harville, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/698,242

(22) Filed: Oct. 31, 2003

(30) Foreign Application Priority Data
Jul. 29, 2002 (JP) P2002-219084

(51) Int. Cl. H04L 9/32

(52) U.S. Cl. 713/201

(57) ABSTRACT

Automated physical access control systems and methods are described. In one aspect, an access control system includes an object detector, a token reader, and an access controller. The object detector is configured to detect persons present within a detection area. The token reader is configured to interrogate tokens present within a token reader area. The access controller is configured to receive signals from the object detector and the token reader. The access controller is configured to compute one or more characteristics linking persons and tokens based upon signals received from the object detector and the token reader and to determine whether detected persons are carrying permissioned tokens based upon the one or more computed characteristics linking persons and tokens.

### CROSS-REFERENCE TO RELATED APPLICATIONS

This application is related to U.S. application Ser. No. 10/133,151, filed on Apr. 26, 2002, by Michael Harville, and entitled “Plan-View Projections of Depth Image Data for Object Tracking,” which is incorporated herein by reference.

### TECHNICAL FIELD

This invention relates to automated physical access control systems and methods.

### BACKGROUND

Many different schemes have been proposed for controlling and monitoring access to restricted areas and restricted resources. For example, keyed and combination locks commonly are used to prevent or limit access to various spaces. Electronic devices, such as electronic alarms and cameras, have been used to monitor secure spaces, and electronically actuated locking and unlocking door mechanisms have been used to limit access to particular areas. Some electronic access control systems include a plurality of room door locks and a central control station that programs access cards with data that enables each access card to open a respective door lock by swiping the access card through a slot in a card reader associated with each door. Other electronic access control systems include wireless card readers that are associated with each door in a facility. Persons may open facility doors by holding an access card near a card reader, which interrogates the card and, if the card contains appropriate authorization data, actuates the door latch to allow the cardholder to pass through the door.

In addition to controlling physical access to restricted areas and restricted resources, some security systems include schemes for identifying individuals before access is granted. In general, these identification schemes may infer an individual's identity based upon knowledge of restricted information (e.g., a password), possession of a restricted article (e.g., a passkey), or one or more inherent physical features of the individual (e.g., a matching reference photo or biometric indicia).

Each of the above-mentioned access control schemes, however, may be compromised by an unauthorized person who follows immediately behind (i.e., tailgates) or passes through an access control space at the same time as (i.e., piggybacks) an authorized person who has been granted access to a restricted area or a restricted resource. Different methods of detecting tailgaters and piggybackers have been proposed. Most of these systems, however, involve the use of a complex door arrangement that defines a confined space through which a person must pass before being granted access to a restricted area. For example, in one anti-piggybacking sensor system for a revolving door, an alarm signal is triggered if more than one person is detected in one or more of the revolving door compartments at any given time. In another approach, a security enclosure for a door frame includes two doors that define a chamber unit that is large enough for only one person to enter at a time to prevent unauthorized entry by tailgating or piggybacking.

### SUMMARY

The invention features automated physical access control systems and methods that facilitate tight control of access to restricted areas or resources by detecting the presence of tailgaters or piggybackers without requiring complex door arrangements that restrict passage through access control areas.

In one aspect, the invention features an access control system, comprising an object detector, a token reader, and an access controller. The object detector is configured to detect persons present within a detection area. The token reader is configured to interrogate tokens present within a token reader area. The access controller is configured to receive signals from the object detector and the token reader. The access controller is configured to compute one or more characteristics linking persons and tokens based upon signals received from the object detector and the token reader and to determine whether each detected person is carrying a permissioned token based upon the one or more computed characteristics linking persons and tokens.

In another aspect, the invention features a method that is implementable by the above-described access control system.

In another aspect of the invention, a person is visually tracked. It is determined whether the tracked person has a permissioned token based on one or more characteristics linking persons and tokens. A signal is generated in response to a determination that the tracked person is free of any permissioned tokens.

In another aspect of the invention, tokens crossing a first boundary of a first area are detected. A count of tokens in the first area is tallied based on the tokens detected crossing the first boundary. Persons crossing a second boundary of a second area are detected. A count of persons in the second area is tallied based on the persons detected crossing the second boundary. A signal is generated in response to a determination that the persons count exceeds the tokens count.

Other features and advantages of the invention will become apparent from the following description, including the drawings and the claims.

### DESCRIPTION OF DRAWINGS

FIG. 1 is a diagrammatic view of an embodiment of an access control system that includes an object detector, a token reader and an access controller, which are installed adjacent to a portal blocking access to a restricted access area.

FIG. 2 is a flow diagram of an embodiment of a method of controlling physical access that may be implemented by the access control system of FIG. 1.

FIG. 3 is a diagrammatic view of an embodiment of an access control system that includes an object detector, two token readers and an access controller, which are installed adjacent to a portal blocking access to a restricted access area.

FIG. 4 is a flow diagram of an embodiment of a method of controlling physical access that may be implemented by the access control system of FIG. 3.

FIG. 5 is a diagrammatic view of an embodiment of an access control system that includes two object detectors, a token reader and an access controller, which are installed in a restricted access area.

FIG. 6 is a flow diagram of an embodiment of a method of controlling physical access that may be implemented by the access control system of FIG. 5.

FIG. 7 is a diagrammatic view of an embodiment of an access control system configured to control access to a restricted access area based on the flow of persons and tokens across two boundaries.

FIG. 8 is a flow diagram of an embodiment of a method of tracking an object.

FIG. 9 is a diagrammatic perspective view of an implementation of a three-dimensional coordinate system for a visual scene and a three-dimensional point cloud spanned by a ground plane and a vertical axis that is orthogonal to the ground plane.

FIG. 10 is a block diagram of an implementation of the method of FIG. 8.

FIG. 11 is a flow diagram of an exemplary implementation of the method shown in FIG. 10.

FIG. 12 is a diagrammatic perspective view of an implementation of the three-dimensional coordinate system of FIG. 9 with the three-dimensional point cloud discretized along the vertical axis into multiple horizontal partitions.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### Controlling Physical Access

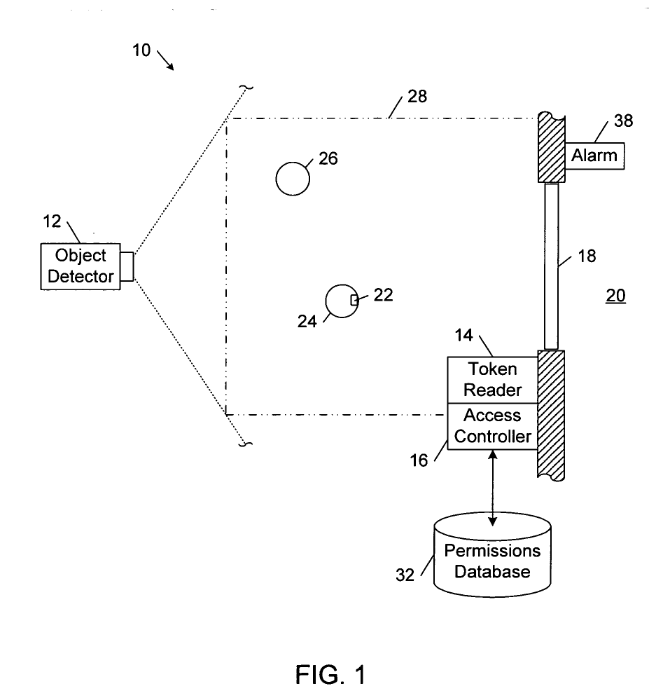

Referring to FIG. 1, in one embodiment, an access control system 10 includes an object detector 12, a token reader 14, and an access controller 16. Access control system 10 is operable to control a portal 18 that is blocking access to a restricted access area 20. In particular, access control system 10 is operable to allow only persons carrying tokens 22 that are embedded with appropriate permission data (hereinafter “permissioned tokens”) to pass through portal 18. Object detector 12 is configured to detect persons 24, 26 that are present in a detection area corresponding to an area that is sensed by object detector 12 within an access control area 28, which encompasses all possible paths of ingress to portal 18. Object detector 12 may be any one of a wide variety of different object detectors, including detectors based on interaction between an object and radiation (e.g., optical radiation, infrared radiation, and microwave radiation) and ultrasonic-based object detectors. In one embodiment, object detector 12 is implemented as a vision-based person tracking system, which is explained in detail below. Token reader 14 is configured to interrogate tokens present in a token reader area corresponding to an area that is sensed by token reader 14 within access control area 28. In some embodiments, token reader 14 may be a conventional token reader that is operable to wirelessly interrogate tokens (e.g., RFID based tokens) that are located within the token reader area. In other embodiments, token reader 14 may be a conventional card swipe reader. Access controller 16 may be a conventional programmable microcomputer or programmable logic device that is operable to compute, based upon signals received from object detector 12 and token reader 14, one or more characteristics linking persons and tokens from which it may be inferred that each of the persons detected within access control area 26 is carrying a respective permissioned token.

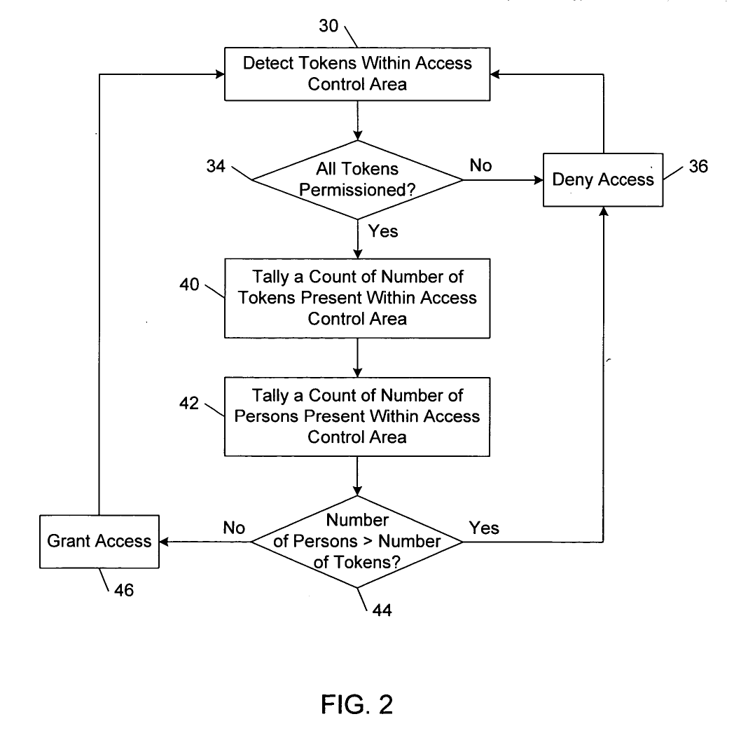

Referring to FIGS. 1 and 2, in some embodiments, the one or more linking characteristics computed by access controller 16 correspond to the numbers of persons and tokens present within access control area 28. In accordance with this embodiment, token reader 14 detects tokens that are carried into access control area 28 (step 30). Access controller 16 queries a permissions database 32 (FIG. 1) to determine whether all of the detected tokens 22 are permissioned (step 34). If the tokens 22 detected by token reader 14 are not all permissioned (step 34), access controller 16 will deny access to the persons within access control area 28 (step 36). In some embodiments, access controller 16 also may generate a signal. In some embodiments the action signal triggers an alarm 38 (e.g., an audible or visible alarm) to warn security personnel that an unauthorized person is attempting to gain access to restricted area 20. In other implementations, the signal triggers a response suitable to the environment in which the access control system is implemented. For example, the action signal may prevent a device, such as a gate (e.g., a gate into a ski lift), from operating until a human administrator overrides the action signal.

If all of the tokens 22 detected by token reader 14 are appropriately permissioned (step 34), access controller 16 tallies a count of the number of tokens present within access control area 28 based upon signals received from token reader 14 (step 40). Access controller 16 also tallies a count of the number of persons present within access control area 28 based upon signals received from object detector 12 (step 42). If the count of the number of persons is greater than the number of tokens count (step 44), access controller 16 denies access to the persons within access control area 28 (step 36). In some embodiments, access controller 16 also may generate a signal that triggers a response from the access control system. For example, in some implementations, the signal triggers alarm 38 to warn security personnel that an unauthorized person (e.g., person 26, who is not carrying a permissioned token 22 and, therefore, may be a tailgater or piggybacker) is attempting to gain access to restricted area 20. In these implementations, if the number of persons count is less than or equal to the 15 number of tokens count (step 44), access controller 16 will grant access to the persons within access control area 28 by unlocking portal 18 (step 46). In some embodiments, access controller 16 will grant access to the persons within access control area 28 only when the number of persons count exactly matches the number of tokens count.

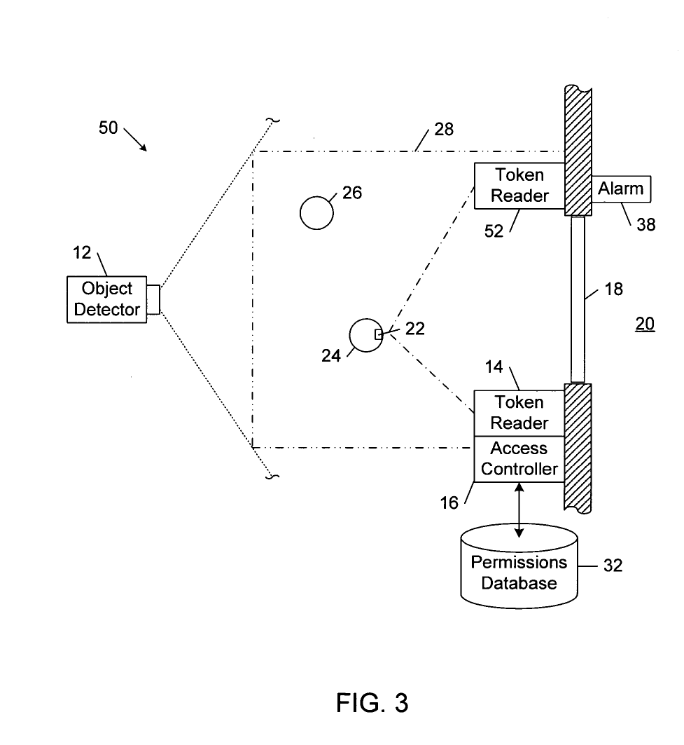

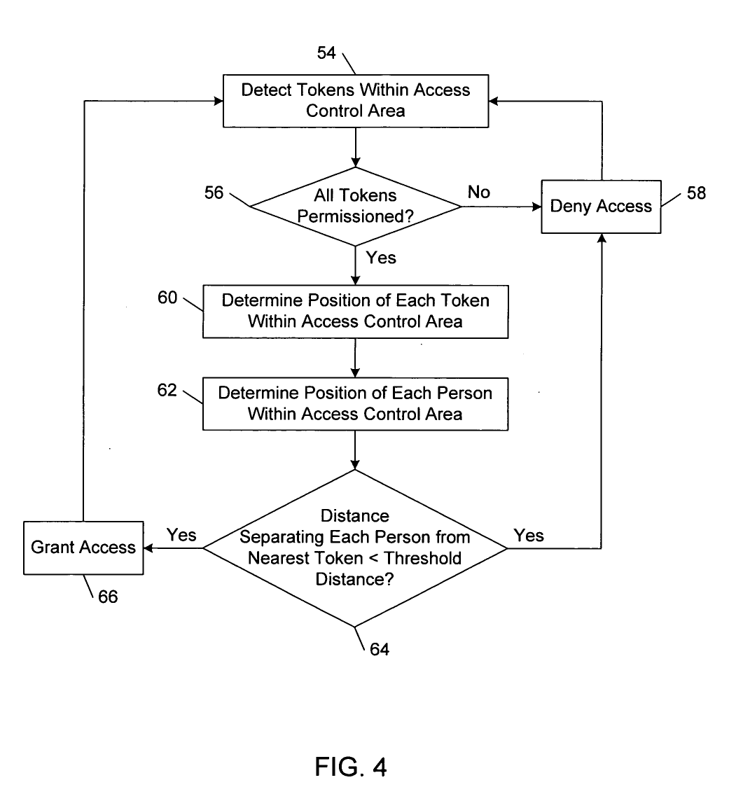

Referring to FIGS. 3 and 4, in some embodiments, the one or more linking characteristics computed by access controller 16 correspond to measures of separation distance between persons and tokens present within access control area 28. In this embodiment, an access control system 50 includes an object detector 12, a pair of token readers 14, 52, and an access controller 16. In accordance with a conventional triangulation process, object detector 12 and token readers 14, 52 are operable to provide sufficient information for access controller 16 to compute measures of separation distance between persons 24, 26 and tokens 22 present within the access control area 28.

In operation, token readers 14, 52 detect tokens that are carried into access 30 control area 28 (step 54). Access controller 16 queries permissions database 32 to determine whether all of the detected tokens 22 are permissioned (step 56). If the tokens 22 detected by token readers 14, 52 are not all permissioned (step 56), access controller 16 will deny access to the persons within access control area 28 (step 58). In some embodiments, access controller 16 also generates a signal, as described above in connection with the embodiment of FIGS. 1 and 2. If all of the tokens 22 detected by token readers 14, 52 are appropriately permissioned (step 56), access controller 16 determines the relative position of each token 22 within control access area 28 (step 60). Access controller 16 also determines the relative position of each person 24, 26 within access control area 28 (step 62). In some implementations, if the distance separating each person 24, 26 from the nearest token 22 is less than a preselected distance (step 64), access controller 16 will grant access to the persons within access control area 28 by unlocking portal 18 (step 66). The preselected distance may correspond to an estimate of the maximum distance a person may carry a token away from his or her body. If the distance separating each person 24, 26 from the nearest token 22 is greater than or equal to the preselected distance (step 64), access controller 16 will deny access to the persons within access control area 28 (step 58). In some embodiments, access controller 16 also may generate a signal that triggers a response, as described above in connection with the embodiment of FIGS. 1 and 2. For example, the action signal may trigger alarm 38 to warn security personnel that an unauthorized person (e.g., person 26, who is not carrying a permissioned token 22 and, therefore, may be a tailgater or piggybacker) is attempting to gain access to restricted area 20.

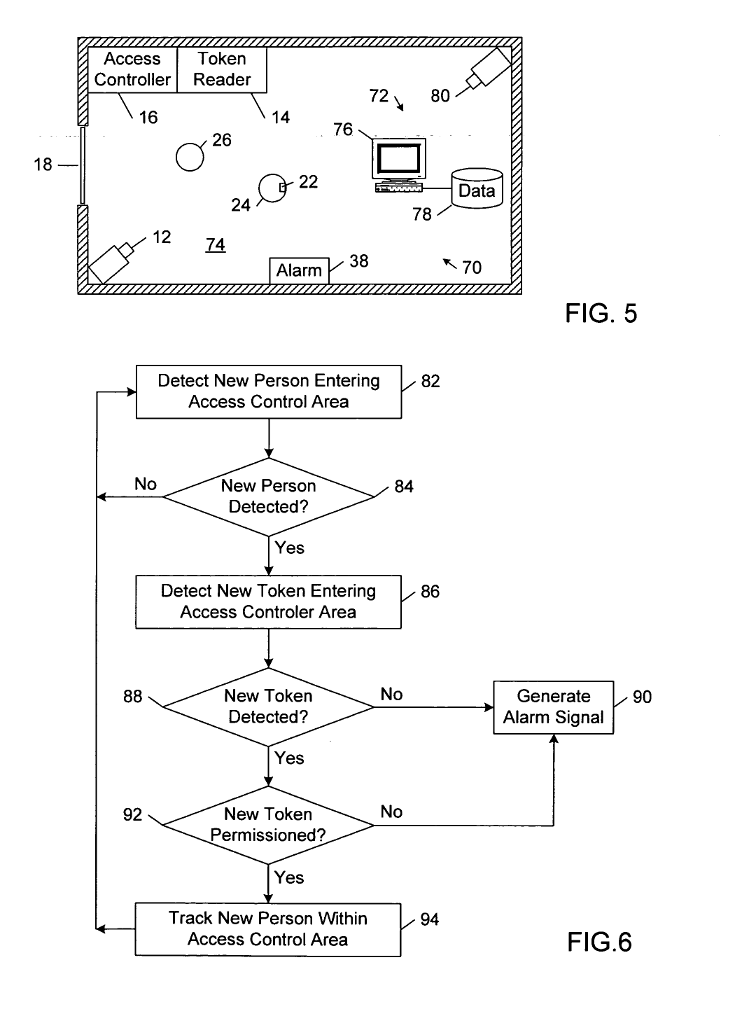

Referring to FIGS. 5 and 6, in some embodiments, an access control system 70 is configured to monitor and control access to a resource 72 that is located within a confined access control area 74. Resource 72 may be a computer 76 through which confidential or proprietary information that is stored in a database 78 may be accessed. Alternatively, resource 72 may be a storage area in which one or more pharmaceutical agents or weapons may be stored. In the illustrated embodiment, access control system 70 includes a pair of object detectors 12, 80, a token reader 14, and an access controller 16. Object detectors 12, 80 are configured to cooperatively track persons located anywhere within access control area 74. Additional object detectors or token readers also may be installed within access control area 74.

In operation, object detectors 12, 80 detect whether a new person 24, 26 has entered access control area 74 (step 82). If a new person is detected (step 84), token reader 14 detects whether a new token has entered access control area 74 (step 86). If a new token is not detected (step 88), access controller 16 generates a signal, such as an alarm signal that triggers alarm 38 to warn security personnel that an unauthorized person (e.g., person 26, who is not carrying a permissioned token 22 and, therefore, may be a tailgater or piggybacker) is attempting to gain access to restricted resource 72 (step 90). If token reader 14 detects a new token within access control area 74 (step 88), access controller 16 queries permissions database 32 to determine whether the detected new token 22 is permissioned (step 92). If the new token 22 detected by token reader 14 is not is permissioned (step 92), access controller 16 generates an action signal (e.g., an alarm signal that triggers alarm 38 to warn security personnel that an unauthorized person is attempting to gain access to restricted resource 72) (step 90). If the new token 22 detected by token reader 14 is appropriately permissioned (step 92), access controller 16 registers the new person in a database and object detectors 12, 80 cooperatively track the movements of the new person within access control area 74 (step 94). In some embodiments, the movements of each of the persons within access control area 74 are time-stamped.

In the illustrated embodiment of FIGS. 5 and 6, the linking characteristics computed by access controller 16 correspond to the numbers of persons and tokens present within access control area 28. In other embodiments, the linking characteristics computed by access controller 16 may correspond to measures of separation distance between persons and tokens present within control access area 74, as described above in connection with the access control system 50 shown in FIG. 3.

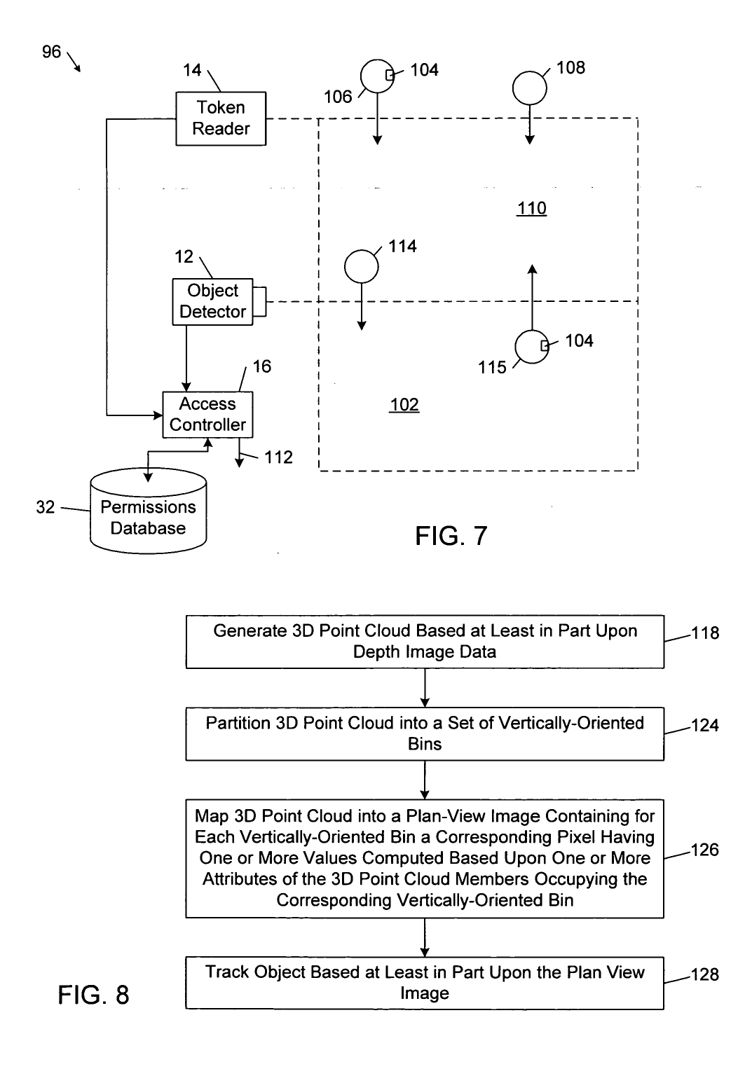

FIG. 7 shows an embodiment of an access control system 96 that is configured to monitor the flow of persons and tokens across two boundaries 98, 100 and to control access to a restricted access area 102 based on a comparison of the numbers of persons and tokens crossing boundaries 98, 100. In particular, access controller 16 allows persons carrying tokens 104 (e.g., person 106) and persons without tokens (e.g., person 108) to cross boundary 98 into area 110, which may be an unrestricted access area. Access controller 16, however, restricts access to restricted access area 102 based on a comparison of the number of tokens determined to be within area 110 and the number of persons determined to be within restricted access area 102.

Token reader 14 detects tokens that are carried across boundary 98 into area 110. In some implementations, token reader 14 may be implemented by two separate token readers, one of which is configured to detect tokens carried into area 110 and the other of which is configured to detect tokens carried out of area 110. Token reader 14 also. detects tokens that are carried across boundary 98 out of area 110. Access controller 16 queries permission database to determine which of the detected tokens 104 are permissioned. Access controller 16 tallies a count of the permissioned tokens in area 110 based on the signal received from token reader 14. In particular, access controller 16 computes the count of persons in area 110 by subtracting the number of persons leaving area 110 from the number persons entering area 110.

Object detector 12 detects persons crossing boundary 100 from area 110 into restricted access area 102. Object detector 12 also detects persons crossing boundary 100 from restricted access area 102 into area 110. Access controller 16 tallies a count of the persons in restricted access area 102 based on the signals received from object detector 12. In particular, access controller 16 computes the count of persons in restricted access area 12 by subtracting the number of persons leaving restricted access area 102 from the number persons entering restricted access area 102.

Access controller 16 generates a signal 112 in response to a determination that the number of detected tokens within area 110 is less than the number of detected persons within restricted access area 102. In some implementations, the signal triggers an alarm to warn security personnel that an unauthorized person (e.g., person 114 who is not carrying a permissioned token and, therefore, may be a tailgater or piggybacker) is attempting to gain access to restricted access area 102. Persons with permissioned tokens (e.g., person 115) are allowed to pass into and out of the restricted access area 102 across boundary 100 without causing access controller 16 to generate a signal.

### Vision-Based Person Tracking Object Detectors

1 Introduction

As explained above, the object detectors in the above-described embodiments may be implemented as vision-based person tracking systems. The person tracking system preferably is operable to detect and track persons based on passive observation of the access control area. In preferred embodiments, the person tracking system is operable to detect and track persons based upon plan-view imagery that is derived at least in part from video streams of depth images representative of the visual scene in the access control area. Briefly, in these embodiments, the person tracking system is operable to generate a point cloud in a three-dimensional coordinate system spanned by a ground plane and a vertical axis orthogonal to the ground plane. The three-dimensional point cloud has members with one or more associated attributes obtained from the video streams and representing selected depth image pixels. The three-dimensional point cloud is partitioned into a set of vertically-oriented bins. The partitioned three-dimensional point cloud is mapped into one or more plan-view images containing for each vertically-oriented bin a corresponding pixel having one or more values computed based upon one or more attributes or a count of the three-dimensional point cloud members occupying the corresponding vertically-oriented bin. The object is tracked based at least in part upon the plan-view image.

The embodiments described in detail below provide an improved solution to the problem of object tracking, especially when only passive (observational) means are allowable. In accordance with this solution, objects may be tracked based upon plan-view imagery that enables much richer and more powerful representations of tracked objects to be developed and used, and therefore leads to significant tracking improvement.

The following description covers a variety of systems and methods of simultaneously detecting and tracking multiple objects in a visual scene using a time series of video frames representative of the visual scene. In some embodiments, a three-dimensional point cloud is generated from depth or disparity video imagery, optionally in conjunction with spatially and temporally aligned video imagery of other types of pixel attributes, such as color or luminance. A “dense depth image” contains at each pixel location an estimate of the distance from the camera to the portion of the scene visible at that pixel. Depth video streams may be obtained by many methods, including methods based on stereopsis (i.e., comparing images from two or more closely-spaced cameras), lidar, or structured light projection. All of these depth measurement methods are advantageous in many application contexts because they do not require the tracked objects to be labeled or tagged, to behave in some specific manner, or to otherwise actively aid in the tracking process in any way. In the embodiments described below, if one or more additional “non-depth” video streams (e.g., color or grayscale video) are also used, these streams preferably are aligned in both space and time with the depth video. Specifically, the depth and non-depth streams preferably are approximately synchronized on a frame-by-frame basis, and each set of frames captured at a given time are taken from the same viewpoint, in the same direction, and with the non-depth frames' field of view being at least as large as that for the depth frame.

Although the embodiments described below are implemented with “depth” video information as an input, these embodiments also may be readily implemented with disparity video information as an input.

In the illustrated embodiments, the detection and tracking steps are performed in three-dimensional (3D) space so that these embodiments supply the 3D spatial trajectories of all objects that they track. For example, in some embodiments, the objects to be tracked are people moving around on a roughly planar floor. In such cases, the illustrated embodiments will report the floor locations occupied by all tracked people at any point in time, and perhaps the elevation of the people above or below the “floor” where it deviates from planarity or where the people step onto surfaces above or below it. These embodiments attempt to maintain the correct linkages of each tracked person's identity from one frame to the next, instead of simply reporting a new set of unrelated person sightings in each frame.

As explained in detail below, the illustrated embodiments introduce a variety of transformations of depth image data (optionally in conjunction with non-depth image data) that are particularly well suited for use in object detection and tracking applications. These transformations are referred to herein as “plan-view” projections.

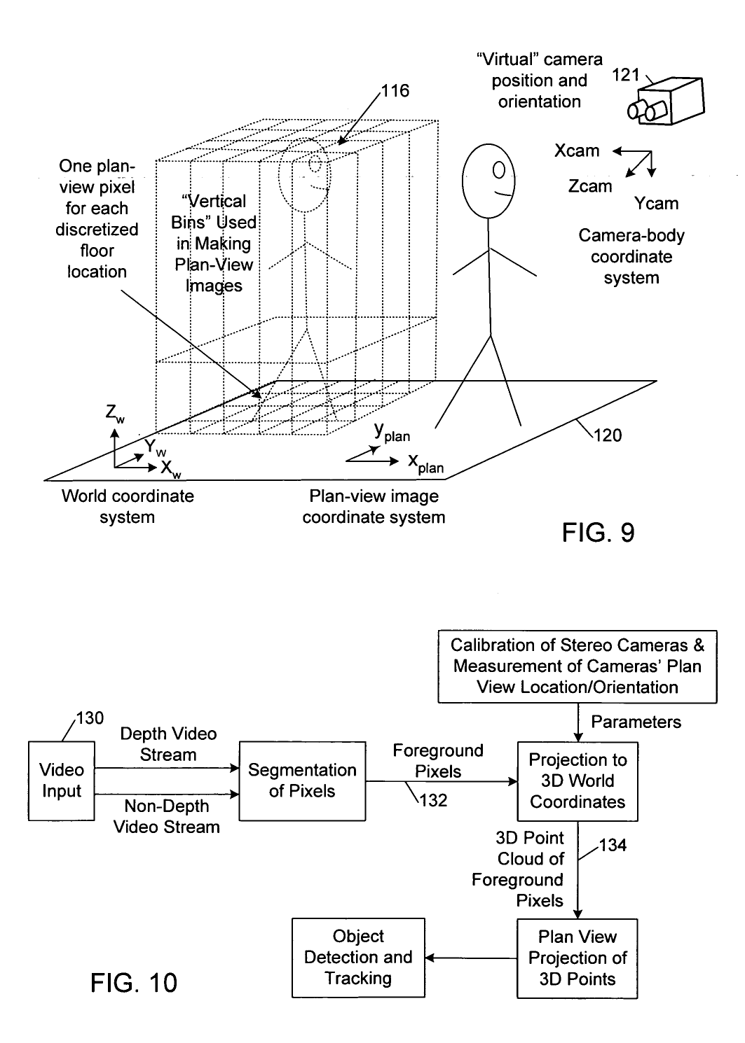

Referring to FIGS. 8 and 9, in some embodiments, an object (e.g., a person) that is observable in a time series of video frames of depth image pixels representative of a visual scene may be tracked based at least in part upon plan-view images as follows.

Initially, a three-dimensional point cloud 116 having members with one or more associated attributes obtained from the time series of video frames is generated (step 118; FIG. 8). In this process, a subset of pixels in the depth image to be used is selected. In some embodiments, all pixels in the depth image may be used. In other embodiments, a subset of depth image pixels is chosen through a process of “foreground segmentation,” in which the novel or dynamic objects in the scene are detected and selected. The precise choice of method of foreground segmentation is not critical. Next, a 3D “world” coordinate system, spanned by X-, Y-, and Z-axes, is defined. The plane 120 spanned by the X- and Y-axes is taken to represent “ground level.” Such a plane 120 need not physically exist; its definition is more akin to that of “sea level” in map-building contexts. In the case of tracking applications in room environments, it is convenient to define “ground level” to be the plane that best approximates the physical floor of the room. The Z-axis (or vertical axis) is defined to be oriented normally to this ground level plane. The position and orientation in this space of the “virtual camera” 121 that is producing the depth and optional non-depth video also is measured. The term “virtual camera” is used to refer to the fact that the video streams used by the system may appear to have a camera center location and view orientation that does not equal that of any real, physical camera used in obtaining the data. The apparent viewpoint and orientation of the virtual camera may be produced by warping, interpolating, or otherwise transforming video obtained by one or more real cameras.

After the three-dimensional coordinated system has been defined, the 3D location of each of the subset of selected pixels is computed. This is done using the image coordinates of the pixel, the depth value of the pixel, the camera calibration information, and knowledge of the orientation and position of the virtual camera in the 3D coordinate system. This step produces a “3D point cloud” 16 representing the selected depth image pixels. If non-depth video streams also are being used, each point in the cloud is labeled with the non-depth image data from the pixel in each non-depth video stream that corresponds to the depth image pixel from which that point in the cloud was generated. For example, if color video is being used in conjunction with depth, each point in the cloud is labeled with the color at the color video pixel corresponding to the depth video pixel from which the point was generated.

Next, the 3D point cloud is partitioned into bins 122 that are oriented vertically (along the Z-axis), normal to the ground level plane (step 124; FIG. 8). These bins 122 typically intersect the ground level XY-plane 120 in a regular, rectangular pattern, but do not need to do so. The spatial extent of each bin 122 along the Z-dimension may be infinite, or it may be truncated to some range of interest for the objects being tracked. For instance, in person-tracking applications, the Z-extent of the bins may be truncated to be from ground level to a reasonable maximum height for human beings.

One or more types of plan-view images may be constructed from this partitioned 3D point cloud (step 126; FIG. 8). Each plan-view image contains one pixel for each bin, and the value at that pixel is based on some property of the members of the 3D point cloud that fall in that bin. Many specific embodiments relying on one or more of these types of plan-view images may be built. Instead, several types of plan-view images are described below. An explanation of how these images may be used in object detection and tracking systems also is provided. Other types of plan-view images may be inferred readily from the description contained herein by one having ordinary skill in the art of object tracking.

As explained in detail below, an object may be tracked based at least in part upon the plan-view image (step 128; FIG. 8). A pattern of image values, referred to herein as a “template”, is extracted from the plan-view image to represent an object at least in part. The object-is tracked based at least in part upon comparison of the object template with regions of successive plan-view images. The template may be updated over time with values from successive/new plan-view images. Updated templates may be examined to determine the quality of their information content. In some embodiments, if this quality is found to be too low, by some metric, a template may be updated with values from an alternative, nearby location within the plan-view image. An updated template may be examined to determine whether or not the plan-view image region used to update the template is likely to be centered over the tracked target object. If this determination suggests that the centering is poor, a new region that is likely to more fully contain the target is selected, and the template is updated with values from this re-centered target region. Although the embodiments described below apply generally to detection and tracking of any type of dynamic object, the illustrated embodiments are described in the exemplary application context of person detection and tracking.

2 Building Maps of Plan-View Statistics

2.1 Overview

The motivation behind using plan-view statistics for person tracking begins with the observation that, in most situations, people usually do not have significant portions of their bodies above or below those of other people.

With a stereo camera, orthographically projected, overhead views of the scene that separate people well may be produced. In addition, these images may be produced even when the stereo camera is not mounted overhead, but instead at an oblique angle that maximizes viewing volume and preserves our ability to see faces. All of this is possible because the depth data produced by a stereo camera allows for the partial 3D reconstruction of the scene, from which new images of scene statistics, using arbitrary viewing angles and camera projection models, can be computed. Plan-view images are just one possible class of images that may be constructed, and are discussed in greater detail below.

Every reliable measurement in a depth image can be back-projected to the 3D scene point responsible for it using camera calibration information and a perspective projection model. By back-projecting all of the depth image pixels, a 3D point cloud representing the portion of the scene visible to the stereo camera may be produced. As explained above, if the direction of the “vertical” axis of the world (i.e., the axis normal to the ground level plane in which it is expected that people are well-separated) is known the space may be discretized into a regular grid of vertically oriented bins, and statistics of the 3D point cloud within each bin may be computed. A plan-view image contains one pixel for each of these vertical bins, with the value at the pixel being some statistic of the 3D points within the corresponding bin. This procedure effectively builds an orthographically projected, overhead view of some property of the 3D scene, as shown in FIG. 9.

2.2 Video Input and Camera Calibration

Referring to FIG. 10, in one implementation of the method of FIG. 8, the input 30 is a video stream of “color-with-depth”; that is, the data for each pixel in the video stream contains three color components and one depth component. In some embodiments, color-with-depth video is produced at 320×240 resolution by a combination of the Point Grey Digiclops camera and the Point Grey Triclops software library (available from Point Grey, Inc. of Vancouver, British Columbia, Canada).

For embodiments in which multi-camera stereo implementations are used to provide depth data, some calibration steps are needed. First, each individual camera's intrinsic parameters and lens distortion function should be calibrated to map each camera's raw, distorted input to images that are suitable for stereo matching. Second, stereo calibration and determination of the cameras' epipolar geometry is required to map disparity image values (x, y, disp) to depth image values (x, y, Z_{cam}). This same calibration also enables us to use perspective back projection to map disparity image values (x, y, disp) to 3D coordinates (X_{cam}, Y_{cam}, Z_{cam}) in the frame of the camera body. The parameters produced by this calibration step essentially enable us to treat the set of individual cameras as a single virtual camera head producing color-with-depth video. In the disparity image coordinate system, the x- and y-axes are oriented left-to-right along image rows and top-to-bottom along image columns, respectively. In the camera body coordinate frame, the origin is at the camera principal point, the X_{cam}-and Y_{cam}-axes are coincident with the disparity image x- and y-axes, and the Z_{cam}-axis points out from the virtual camera's principal point and is normal to the image plane. The parameters required from this calibration step are the camera baseline separation b, the virtual camera horizontal and vertical focal lengths fₓ and fₓ (for the general case of non-square pixels), and the image location (x₀, y₀) where the virtual camera's central axis of projection intersects the image plane.

In general, the rigid transformation relating the camera body (X_{cam}, Y_{cam}, Z_{cam}) coordinate system to the (X_{w}, Y_{w}, Z_{w}) world space must be determined so that “overhead” direction may be determined, and so that the distance of the camera above the ground may be determined. Both of these coordinate systems are shown in FIG. 9. The rotation matrix R_{cam} and translation vector \vec{t}_{cam} required to move the real stereo camera into alignment with an imaginary stereo camera located at the world origin and with X_{cam}-, Y_{cam}-, and Z_{cam}-axes aligned with the world coordinate axes are computed.

Many standard methods exist for accomplishing these calibration steps. Since calibration methods are not our focus here, particular techniques are not described, but instead the requirements are set forth that, whatever methods are used, they result in the production of distortion-corrected color-with-depth imagery, and they determine the parameters b, fₓ, f_{y}, (x₀, y₀), R_{cam}, and \vec{t}_{cam} described above.

In some embodiments, to maximize the volume of viewable space without making the system overly susceptible to occlusions, the stereo camera is mounted at a relatively high location, with the central axis of projection roughly midway between parallel and normal to the XY-plane. In these embodiments, the cameras are mounted relatively close together, with a separation of 10-20 cm. However, the method is applicable for any positioning and orientation of the cameras, provided that the above calibration steps can be performed accurately. Lenses with as wide a field of view as possible preferably are used, provided that the lens distortion can be well-corrected.

2.3 Foreground Segmentation

In some embodiments, rather than use all of the image pixels in building plan-view maps, only objects in the scene that are novel or that move in ways that are atypical for them are considered. In the illustrated embodiments, only the “foreground” in the scene is considered. Foreground pixels 32 are extracted using a method that models both the color and depth statistics of the scene background with Time-Adaptive, Per-Pixel Mixtures Of Gaussians (TAPPMOGs), as detailed in U.S. patent application Ser. No. 10/006,687, filed Dec. 10, 2001, by Michael Harville, and entitled “Segmenting Video Input Using High-Level Feedback,” which is incorporated herein by reference. In summary, this foreground segmentation method uses a time-adaptive Gaussian mixture model at each pixel to describe the recent history of observations at that pixel. Observations are modeled in a four-dimensional feature space consisting of depth, luminance, and two chroma components. A subset of the Gaussians in each pixel's mixture model is selected at each time step to represent the background. At each pixel where the current. color and depth are well-described by that pixel's background model, the current video data is labeled as background. Otherwise, it is labeled as foreground. The foreground is refined using connected components analysis. This foreground segmentation method is significantly more robust than other, prior pixel level techniques to a wide variety of challenging, real world phenomena, such as shadows, inter-reflections, lighting changes, dynamic background objects (e.g. foliage in wind), and color appearance matching between a person and the background. In these embodiments, use of this method enables the person tracking system to function well for extended periods of time in arbitrary environments.

In some embodiments where such robustness is not required in some context, or where the runtime speed of this segmentation method is not sufficient on a given platform, one may choose to substitute simpler, less computationally expensive alternatives at the risk of some degradation in person tracking performance. Of particular appeal is the notion of using background subtraction based on depth alone. Such methods typically run faster than those that make use of color, but must deal with what to do at the many image locations where depth measurements have low confidence (e.g., in regions of little visual texture and in regions, often near depth discontinuities in the scene, that are visible in one image but not the other).

In some embodiments, color data may be used to provide an additional cue for making better decisions in the absence of quality depth data in either the foreground, background, or both, thereby leading to much cleaner foreground segmentation. Color data also usually is far less noisy than stereo-based depth measurements, and creates sharper contours around segmented foreground objects. Despite all of this, it has been found that foreground segmentation based on depth alone is usually sufficient to enable good performance of our person tracking method. This is true in large part because subsequent steps in the method ignore portions of the foreground for which depth is unreliable. Hence, in situations where computational resources are limited, it is believed that depth-only background subtraction is alternative that should be considered.

2.4 Plan-View Height and Occupancy Images

In some embodiments, each foreground pixel with reliable depth is used in building plan-view images. The first step in building plan-view images is to construct a 3D point cloud 134 (FIG. 10) from the camera-view image of the foreground. For implementations using a binocular stereo pair with horizontal separation b, horizontal and vertical focal lengths fᵤ, and fᵥ, and image center of projection (u, v,), the disparity (disp) at camera-view foreground pixel (u, v) is projected to a 3D location (X_{cam}, Y_{cam}, Z_{cam}) in the camera body coordinate frame (see FIG. 8) as follows:

$${Z}_{cam} = \frac{b {f}_{u}}{disp} , {X}_{cam} = \frac{{Z}_{cam} ( u - {u}_{0} )}{{f}_{u}} , {Y}_{cam} = \frac{{Z}_{cam} ( v - {v}_{0} )}{{f}_{v}} \qquad ( 1 )$$

These camera frame coordinates are transformed into the (X_{w},Y_{w}, Z_{w}) world space, where the Z_{w} axis is aligned with the “vertical” axis of the world and the X_{w} and Y_{w} axes describe a ground level plane, by applying the rotation R_{cam} and translation \vec{t}_{cam} relating the coordinate systems:

[X_{w}Y_{w}Z_{w}]^{T}=−R_{cam}[X_{cam}Y_{cam} Z_{cam}]^{T}−\vec{t}_{cam} (2)

The points in the 3D point cloud are associated with positional attributes, such as their 3D world location (X_{w}, Y_{w}, Z_{w}), where Z_{w} is the height of a point above the ground level plane. The points may also be labeled with attributes from video imagery that is spatially and temporally aligned with the depth video input. For example, in embodiments constructing 3D point clouds from foreground data extracted from color-with-depth video, each 3D point may be labeled with the color of the corresponding foreground pixel.

Before building plan-view maps from the 3D point cloud, a resolution δ_{ground} with which to quantize 3D space into vertical bins is selected. In some embodiments, this resolution is selected to be small enough to represent the shapes of people in detail, within the limitations imposed by the noise and resolution properties of the depth measurement system. In one implementation, the X_{w}Y_{w}-plane is divided into a square grid with resolution δ_{ground} of 2-4 cm.

After choosing the bounds (Xₘᵢₙ, Xₘₐₓ , Yₘᵢₙ , Yₘₐₓ) of the ground level area of focus, 3D point cloud coordinates are mapped to their corresponding plan-view image pixel locations as follows:

Xₚₗₐₙ=└(X_{W}−Xₘᵢₙ)/δ_{ground}+0.5┘yₚₗₐₙ=└(Y_{w}−Yₘᵢₙ)/δ_{ground}+0.5 ┘ (3)

In some embodiments, statistics of the point cloud that are related to the counts of the 3D points within the vertical bins are examined. When such a statistic is used as the value of the plan-view image pixel that corresponds to a bin, the resulting plan-view image is referred to as a “plan-view occupancy map”, since the image effectively describes the quantity of point cloud material “occupying” the space above each floor location. Although powerful, this representation discards virtually all object shape information in the vertical (Z_{w}) dimension. In addition, the occupancy map representation of an object will show a sharp decrease in saliency when the object moves to a location where it is partially occluded by another object, because far fewer 3D points corresponding to the object will be visible to the camera.

The statistics of the Z_{w}-coordinate attributes of the point cloud members also may be examined. For simplicity, Z_{w}-values are referred to as “height” since it is often the case that the ground level plane, where Z_{w}=0, is chosen to approximate the floor of the physical space in which tracking occurs. One height statistic of particular utility is the highest Z_{w}-value (the “maximum height”) associated with any of the point cloud members that fall in a bin. When this is used as the value at the plan-view image pixel that corresponds to a bin, the resulting plan-view image is referred to as a “plan-view height map,” since it effectively renders an image of the shape of the scene as if viewed (with orthographic camera projection) from above. Height maps preserve about as much 3D shape information as is possible in a 2D image, and therefore seem better suited than occupancy maps for distinguishing people from each other and from other objects. This shape data also provides richer features than occupancy for accurately tracking people through close interactions and partial occlusions. Furthermore, when the stereo camera is mounted in a high position at an oblique angle, the heads and upper bodies of people often remain largely visible during inter-person occlusion events, so that a person's height map representation is usually more robust to partial occlusions than the corresponding occupancy map statistics. In other embodiments, the sensitivity of the “maximum height” height map may be reduced by sorting the points in each bin according to height, and use something like the 90^{th} percentile height value as the pixel value for the plan-view map. Use of the point with maximal, rather than, for example, 90^{th} percentile, height within each vertical bin allows for fast computation of the height map, but makes the height statistics very sensitive to depth noise. In addition, the movement of relatively small objects at heights similar to those of people's heads, such as when a book is placed on an eye-level shelf, can appear similar to person motion in a height map. Alternative types of plan-view maps based on height statistics could use the minimum height value of all points in a bin, the average height value of bin points, the median value, the standard deviation, or the height value that exceeds the heights of a particular percentage of other points in the bin.

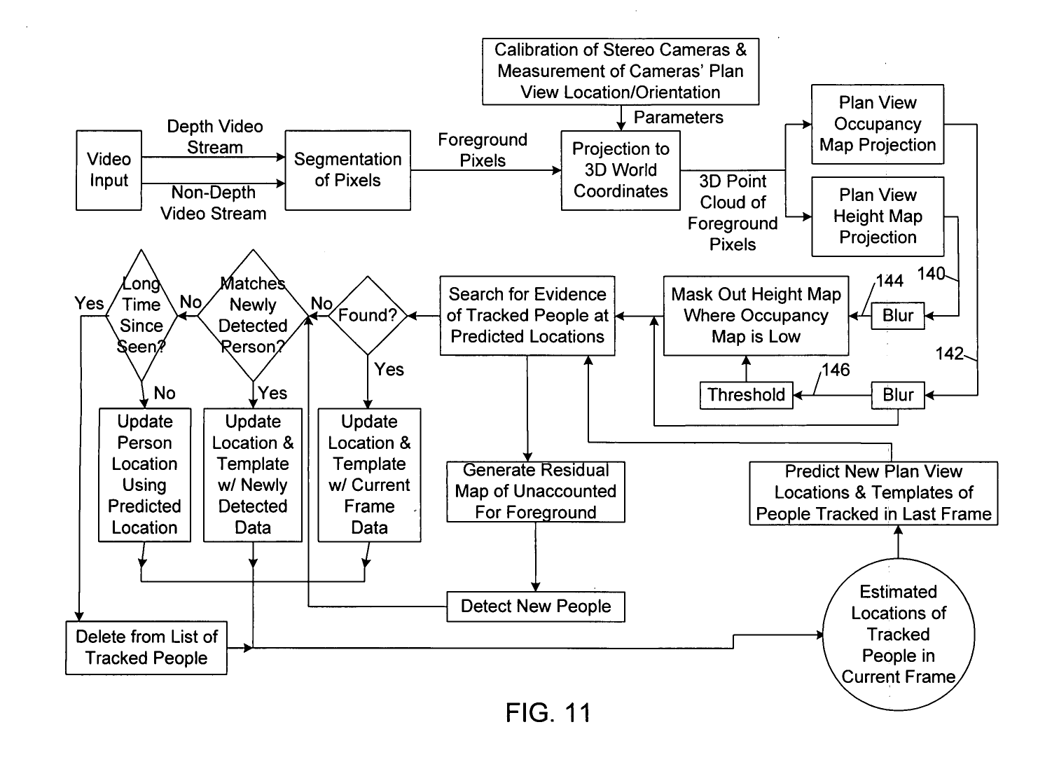

Referring to FIG. 11, in one implementation of the method of FIG. 10, plan-view height and occupancy maps 140, 142, denoted as [symbol] and [symbol] respectively, are computed in a single pass through the foreground image data. The methods described in this paragraph apply more generally to any selected pixels of interest for which depth or disparity information is available, but the exemplary case of using foreground pixels is illustrated here. To build the plan-view maps, all pixels in both maps are set to zero. Then, for each pixel classified as foreground, its plan-view image location (xₚₗₐₙ, Yₚₗₐₙ), Z_{w}-coordinate, and Z_{cam}-coordinate are computed using equations (1), (2), and (3). If the Z_{w}-coordinate is greater than the current height map value [symbol] (xₚₗₐₙ, yₚₗₐₙ), and if it does not exceed Hₘₐₓ where, in one implementation, Hₘₐₓ is an estimate of how high a very tall person could reach with his hands if he stood on his toes, [symbol] (xₚₗₐₙ, yₚₗₐₙ) is set equal to Z_{w}. Next the occupancy map value [symbol] (xₚₗₐₙ,yₚₗₐₙ) is incremented by Z²_{cam/f}ᵤf_{y}, which is an estimate of the real area subtended by the foreground image pixel at distance Z_{cam} from the camera. The plan-view occupancy map will therefore represent the total physical surface area of foreground visible to the camera within each vertical bin of the world space.

Because of the substantial noise in these plan-view maps, these maps are denoted as [symbol] _{aw} and [symbol] _{aw}. In some embodiments, these raw plan-view maps are smoothed prior to further analysis. In one implementation, the smoothed maps 144, 146, denoted [symbol] ₛₘ and [symbol] ₛₘ, are generated by convolution with a Gaussian kernel whose variance in plan-view pixels, when multiplied by the map resolution δground, corresponds to a physical size of 1-4 cm. This reduces depth noise in person shapes, while retaining gross features like arms, legs, and heads.

Although the shape data provided by [symbol] ₛₘ is very powerful, it is preferred not to give all of it equal weight. In some embodiments, the smoothed height map statistics are used only in floor areas where something “significant” is determined to be present, as indicated, for example, by the amount of local occupancy map evidence. In these embodiments, [symbol] ₛₘ is pruned by setting it to zero wherever the corresponding pixel in [symbol] ₛₘ, is below a threshold θ_{occ}. By refining the height map statistics with occupancy statistics, foreground noise that appears to be located at “interesting” heights may be discounted, helping us to ignore the movement of small, non-person foreground objects, such as a book or sweater that has been placed on an eye-level shelf by a person. This approach circumvents many of the problems of using either statistic in isolation.

3 Tracking and Adapting Templates of Plan-View Statistics

3.1 Person Detection

Anew person in the scene is detected by looking for a significant “pile of pixels” in the occupancy map that has not been accounted for by tracking of people found in previous frames. More precisely, after tracking of known people has been completed, and after the occupancy and height evidence supporting these tracked people has been deleted from the plan-view maps, the occupancy map [symbol] ₛₘ is convolved with a box filter and find the maximum value of the result.

If this peak value is above a threshold θ_{newOcc}, its location is regarded as that of a candidate new person. The box filter size is again a physically-motivated parameter, with width and height equal to an estimate of twice the average torso width W_{avg} of people. A value of W_{avg} around 75 cm is used. For most people, this size encompasses the plan-view representation not just of the torso, but also includes most or all of person's limbs.

Additional tests [symbol] _{masked} and [symbol] ₛₘ are applied at the candidate person location to better verify that this is a person and not some other type of object. In some implementations, two simple tests must be passed:

1. The highest value in [symbol] _{masked} within a square of width W_{avg} centered at the candidate person location must exceed some plausible minimum height θ_{newHt} for people.

2. Among the camera-view foreground pixels that map to the plan-view square of width W_{avg} centered at the candidate person location, the fraction of those whose luminance has changed significantly since the last frame must exceed a threshold θ_{newAct}.

These tests ensure that the foreground object is physically large enough to be a person, and is more physically active than, for instance, a statue. However, these tests may sometimes exclude small children or people in unusual postures, and sometimes may fail to exclude large, non-static, non-person objects such as foliage in wind. Some of these errors may be avoided by restricting the detection of people to certain entry zones in the plan-view map.

Whether or not the above tests are passed, after the tests have been applied, the height and occupancy map data within a square of width W_{avg} centered at the location of the box filter convolution maximum are deleted. The box filter is applied to [symbol] ₛₘ again to look for another candidate new person location. This process continues until the convolution peak value falls below θ_{newOcc}, indicating that there are no more likely locations at which to check for newly occurring people.

In detecting a new person to be tracked, it is desirable to detect a person without substantial occlusion for a few frames before he is officially added to the “tracked person” list. Therefore the new person occupancy threshold θ_{newOcc} is set so that half of an average-sized person must be visible to the stereo pair in order to exceed it. This is approximately implemented using θ_{newOcc}=½×½×W_{avg} [symbol] _{avg}, where W_{avg} and [symbol] _{avg} denote average person width and height, and where the extra factor of ½ compensates for the non-rectangularity of people and the possibility of unreliable depth data. The detection of a candidate new person also is not allowed within some small plan-view distance (e.g., 2×W_{avg}) of any currently tracked -people, so that our box filter detection mechanism is less susceptible to exceeding θ_{newOcc} due to contribution of occupancy from the plan-view fringes of more than one person. Finally, after a new person is detected, he remains only a “candidate” until he is tracked successfully for some minimum number of consecutive frames. No track is reported while the person is still a candidate, although the track measured during this probational period may be retrieved later.

3.2 Tracking with Plan-View Templates

In the illustrated embodiments, classical Kalman filtering is used to track patterns of plan-view height and occupancy statistics over time. The Kalman state maintained for each tracked person is the three-tuple <\vec{x}, \vec{v}, \vec{S})>, where \vec{x} is the two-dimensional plan-view location of the person, \vec{v}is the two-dimensional plan-view velocity of the person, and \vec{S} represents the body configuration of the person. In some embodiments, body configuration may be parameterized in terms of joint angles or other pose descriptions. In the illustrated embodiments, however, it has been observed that simple templates of plan-view height and occupancy statistics provide an easily computed but powerful shape description. In these embodiments, the \vec{S} component of the Kalman state is updated directly with values from subregions of the [symbol] _{masked} and [symbol] ₛₘ images, rather than first attempt to infer body pose from these statistics, which is likely an expensive and highly error-prone process. The Kalman state may therefore more accurately be written as <\vec{x}, \vec{v}, T_{H},T_{O}), where T_{H} and T_{O} are a person's height and occupancy templates, respectively. The observables in this Kalman framework are the same as the state; that is, it is assumed that there are no hidden state variables.

For Kalman prediction in the illustrated embodiments, a constant velocity model is used, and it is assumed that person pose varies smoothly over time. At high system frame rates, it is expected that there is little change in a person's template-based representation from one frame to the next. For simplicity, it is assumed that there no change at all. Because the template statistics for a person are highly dependent on the visibility of that person to the camera, this assumption effectively predicts no change in the person's state of occlusion between frames. These predictions will obviously not be correct in general, but they will become increasingly accurate as the system frame rate is increased. Fortunately, the simple computations employed by this method are well-suited for high-speed implementation, so that it is not difficult to construct a system that operates at a rate where our predictions are reasonably approximate.

The measurement step of the Kalman process is carried out for each person individually, in order of our confidence in their current positional estimates. This confidence is taken to be proportional to the inverse of σ_{\vec{x}}², the variance for the Kalman positional estimate \vec{x}. To obtain a new position measurement for a person, the neighborhood of the predicted person position \vec{x}_{pred} is searched for the location at which the current plan-view image statistics best match the predicted ones for the person. The area in which to search is centered at \vec{x}_{pred}, with a rectangular extent determined from σ_{\vec{x}}². A match score M is computed at all locations within the search zone, with lower values of M indicating better matches. The person's match score M at plan-view location \vec{x} is computed as:

M(\vec{x})=α*SAD(T_{H},H_{masked}(\vec{x}))+β*SAD(T_{O},Oₛₘ(\vec{x}))+y* DISTANCE(\vec{x}_{pred},\vec{x}) (4)

SAD refers to “sum of absolute differences,” but averaged over the number of pixels used in the differencing operation so that all matching process parameters are independent of the template size. For the height SAD, a height difference of Hₘₐₓ/3 is used at all pixels where T_{H} has been masked to zero but [symbol] ₛₘ masked has not, or vice versa. This choice of matching score makes it roughly linearly proportional to three metrics that are easily understood from a physical standpoint:

1. The difference between the shape of the person when seen from overhead, as indicated by T_{H}, and that of the current scene foreground, as indicated by the masked height map, in the neighborhood of (x, y).

2. The difference between the tracked person's visible surface area, as indicated by T_{O}, and that of the current-scene foreground, as indicated by the smoothed occupancy map, in the neighborhood of (x, y).

3. The distance between (x, y) and the predicted person location.

In some embodiments, the weightings α and β are set so that the first two types of differences are scaled similarly. An appropriate ratio for the two values can be determined from the same physically motivated constants that were used to compute other parameters. The parameter γ is set based on the search window size, so that distance will have a lesser influence than the template comparison factors. It has been found in practice that γ can be decreased to zero without significantly disrupting tracking, but that non-zero values of γ help to smooth person tracks.

In some embodiments, when comparing a height template T_{H} to [symbol] _{masked} via the SAD operation, differences at pixels where one height value has been masked out but the other has not are not included, as this might artificially inflate the SAD score. On the other hand, if [symbol] _{masked} is zero at many locations where the corresponding pixels of T_{H} are not, or vice versa, it is desirable for the SAD to reflect this inconsistency somehow. Therefore, in some embodiments, the SAD process, for the height comparison only, is modified to substitute a random height difference whenever either, but not both, of the corresponding pixels of [symbol] _{masked} and T_{H} are zero. The random height difference is selected according to the probability distribution of all possible differences, under the assumption that height values are distributed uniformly between 0 and Hₘₐₓ.

In these embodiments, if the best (minimal) match score found falls below a threshold θtrack, the Kalman state is updated with new measurements. The location \vec{x}_{best} at which M(\vec{x}) was minimized serves as the new position measurement, and the new velocity measurement is the inter-frame change in position divided by the time difference. The statistics of [symbol] _{masked} and [symbol] ₛₘ surrounding \vec{x}_{best} are used as the new body configuration measurement for updating the templates. This image data is cleared before tracking of another person is attempted. A relatively high Kalman gain is used in the update process, so that templates adapt quickly.

If the best match score is above θ_{track}, the Kalman state is not updated with new measurements, and \vec{x}_{pred} is reported as the person's location. The positional state variances are incremented, reflecting our decrease in tracking confidence for the person. The person is also placed on a temporary list of “lost” people.

After template-based tracking and new person detection have been completed, it is determined, for each lost person, whether or not any newly detected person is sufficiently close in space (e.g. 2 meters) to the predicted location of the lost person or to the last place he was sighted. If so, and if the lost person has not been lost too long, it is decided that the two people are a match, and the lost person's Kalman state is set to be equal to that of the newly detected person. If a lost person cannot be matched with any newly detected person, it is considered how long it has been since the person was successfully tracked. If it has been too long (above some time threshold such as 4 seconds), it is decided that the person is permanently lost, and he is deleted from the list of people being tracked.

3.3 Avoidance of Adaptive Template Problems

Most template-based tracking methods that operate on camera-view images encounter difficulty in selecting and adapting the appropriate template size for a tracked object, because the size of the object in the image varies with its distance from the camera. In the plan-view framework described above, however, good performance is obtained with a template size that remains constant across all people and all time. Specifically, the system uses square templates whose sides have a length in pixels that, when multiplied by the plan-view map resolution δ_{ground}, is roughly equal to W_{avg}, which is an estimate of twice the average torso width of people.

This is reasonable because of a combination of two factors. The first of these is that our plan-view representations of people are, ideally, invariant to the floor locations of the people relative to the camera. In practice, the plan-view statistics for a given person become more noisy as he moves away from the camera, because of the smaller number of camera-view pixels that contribute to them. Nevertheless, some basic properties of these statistics, such as their typical magnitudes and spatial extents, do not depend on the person's distance from the camera, so that no change in template size is necessitated by the person's movement around the room.

The other factor allowing us to use a fixed template size is that people spend almost all of their waking time in a predominantly upright position (even when sitting), and the spatial extents of most upright people, when viewed from overhead, are confined to a relatively limited range. If the average width of an adult human torso, from shoulder to shoulder, is somewhere between 35-45 cm, then our template width W_{avg} of 75 cm can be assumed to be large enough to accommodate the torsos of nearly all upright people, as well as much of their outstretched limbs, without being overly large for use with small or closely-spaced people. For people of unusual size or in unusual postures, this template size-still works well, although perhaps it is not ideal. In some implementations, the templates adapt in size when appropriate.

Templates that are updated over time with current image values inevitably “slip off” the tracked target, and begin to reflect elements of the background. This is perhaps the primary reason that adaptive templates are seldom used in current tracking methods, and our method as described thus far suffers from this problem as well. However, with our plan-view statistical basis, it is relatively straightforward to counteract this problem in ways that are not feasible for other image substrates. Specifically, template slippage may be virtually eliminated through a simple “re-centering” scheme, detailed below, that is applied on each frame after tracking has completed.

For each tracked person, the quality of the current height template T [symbol] is examined. If the fraction of non-zero pixels in T_{H} has fallen below a threshold θ_{HTcount} (around 0.3), or if the centroid of these non-zero pixels is more than a distance θ_{HTcentroid} (around 0.25 ×W_{avg}) from the template center, it is decided that the template has slipped too far off the person. A search is conducted, within a square of width W_{avg} centered at the person's current plan-view position estimate, for the location \vec{x}_{occmax} in [symbol] ₛₘ of the local occupancy maximum. New templates T [symbol] and T [symbol] then are extracted from [symbol] _{masked} and [symbol] ₛₘ at \vec{x}_{occmax}. Also, the person location in the Kalman state vector is shifted to \vec{x}_{occmax}, without changing the velocity estimates or other Kalman filter parameters.

It has been found that this re-centering technique is very effective in keeping templates solidly situated over the plan-view statistics representing a person, despite depth noise, partial occlusions, and other factors. This robustness arises from our ability to use the average person size W_{avg} to constrain both our criteria for detecting slippage and our search window for finding a corrected template location.

4 Other Embodiments

4.1 Plan-View Images of Associated, Non-Positional Features

In Section 3.1 above, plan-view images are made with values that are derived directly from statistics of the locations of the points in the 3D point clouds. The positional information of these points is derived entirely from a depth image. In the case where the depth video stream is associated with additional spatially and temporally-registered video streams (e.g., color or grayscale video), each of the points in the 3D point cloud may be labeled with non-positional data derived from the corresponding pixels in the non-depth video streams. This labeling may be carried out in step 118 of the object tracking method of FIG. 8. In general, plan-view images may be vector-valued (i.e., they may contain more than one value at each pixel). For instance, a color plan-view image, perhaps one showing the color of the highest point in each bin, is a vector-valued image having three values (called the red level, green level, and blue level, typically) at each pixel. In step 26 of the object tracking method of FIG. 8, the associated, non-positional labels may be used to compute the plan-view pixel values representing the points that fall in the corresponding vertical bins.

For example, in some embodiments, when using depth and color video streams together, plan-view images showing the color associated with the highest point (the one with maximum Z-value) in each vertical bin may be constructed. This effectively renders images of the color of the scene as if viewed (with orthographic camera projection) from above. If overhead views of the scene are rendered in grayscale, the color values may be converted to grayscale, or a grayscale input video stream is used instead of color. In other embodiments, plan-view images may be created that show, among other things, the average color or gray value associated with the 3D points within each bin, the brightest or most saturated color among points in each bin, or the color associated with the point nearest the average height among points in the bin. In other embodiments, the original input to the system may be one video stream of depth and one or more video streams of features other than color or gray values, such as infrared sensor readings, vectors showing estimates of scene motion at each pixel, or vectors representing the local visual texture in the scene. Plan-view images whose values are derived from statistics of these features among the 3D points falling in each vertical bin may be constructed.

In these embodiments, a person detection and tracking system may be built using the same method as described above, but with substitution for plan-view templates of height data with plan-view templates based on data from these other types of plan-view images. For instance, in some embodiments, plan-view templates of the color associated with the highest points in each of the bins may be used, rather than templates of the heights of these points.

4.2 Plan-View Slices

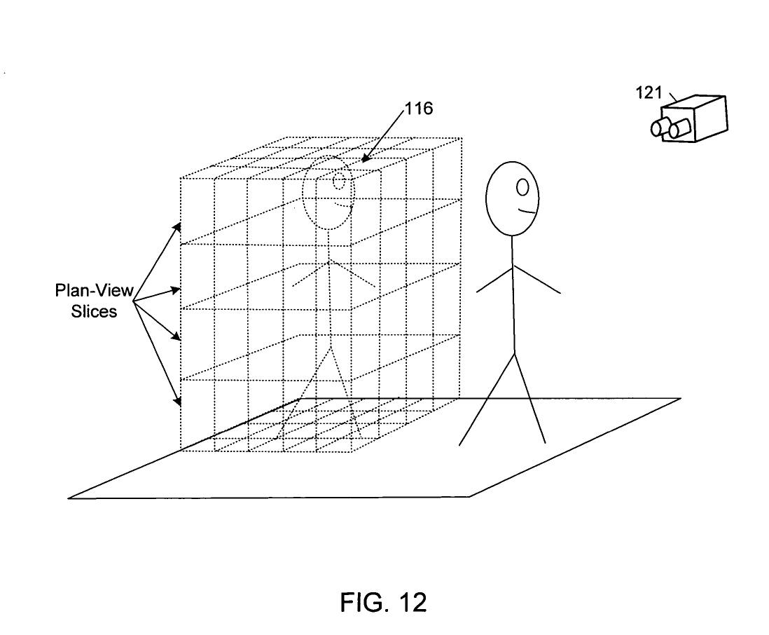

All of the plan-view images discussed thus far have been constructed from a discretization of 3D space in only two dimensions, into vertical bins oriented along the Z-axis. These bins had either infinite or limited extent, but even in the case of limited extent it has been assumed that the bins covered the entire volume of interest. In some embodiments, space is further discretized along the third, Z-dimension, as shown in FIG. 12. In these embodiments, within the volume of interest in 3D space, each vertical bin is divided into several box-shaped sub-bins, by introducing dividing planes that are parallel to the ground-level plane. Any of the techniques for building plan-view images described above may be applied, including those for building occupancy maps, height maps, or maps of associated non-positional features, to only a “slice” of these boxes (i.e., a set of boxes whose centers lie in some plane parallel to the ground-level plane).

In these embodiments, the Z-dimension may be divided into any number of such slices, and one or more plan-view images can be constructed using the 3D point cloud data within each slice. For instance, in a person-tracking application, space between Z=0 and Z=Hₘₐₓ (where Hₘₐₓ is a variable representing, e.g., the expected maximum height of people to be tracked) may be divided into three slices parallel to the ground-level plane. One of these slices might extend from Z=0 to Z=Hₘₐₓ/3 and would be expected to contain most of the lower parts of people's bodies, a second slice might extend from Z=Hₘₐₓ/3 to Z=2Hₘₐₓ/3 and would usually include the middle body parts, and a third slice might run from Z=2Hₘₐₓ/3 to Z=Hₘₐₓ and would typically include the upper body parts. In general, the slices do not need to be adjacent in space, and may overlap if desired. Using the 3D point cloud members within a given slice, the system may compute a plan-view occupancy map, a plan-view height map, a map of the average color within each box in the slice, or other plan-view maps, as described in preceding sections.

After obtaining one or more plan-view maps per slice, the system may apply tracking techniques, such as the one described above or close derivatives, to the maps obtained for each slice. For the example given above, the system might apply three trackers in parallel: one for the plan-view maps generated for the lowest slice, one for the middle slice's plan-view maps, and one for the highest slice's plan-view maps. To combine the results of these independent trackers into a single set of coherent detection and tracking results, the system would look for relationships between detection and tracking results in different layers that have similar (X,Y) coordinates (i.e. that are relatively well-aligned along the Z-axis). For the example given above, this might mean, for instance, that the system would assume that an object tracked in the highest layer and an object tracked in the lowest layer are parts of the same person if the (X,Y) coordinates of the centers of these two objects are sufficiently close to each other. It may be useful to not allow the trackers in different slices to run completely independently, but rather to allow the tracker results for a given slice to partially guide the other slices' trackers' search for objects. The tracking of several sub-parts associated with a single object also allows for greater robustness, since failure in tracking any one sub-part, perhaps due to its occlusion by other objects in the scene, may be compensated for by successful tracking of the other parts.

Additional details regarding the structure and operation of the plan-view based person tracking system may be obtained from U.S. application Ser. No. 10/133,151, filed on Apr. 26, 2002, by Michael Harville, and entitled “Plan-View Projections of Depth Image Data for Object Tracking.”

Systems and methods have-been described herein in connection with a particular access control computing environment. These systems and methods, however, are not limited to any particular hardware or software configuration, but rather they may be implemented in any computing or processing environment, including in digital electronic circuitry or in computer hardware, firmware or software. In general, the components of the access control systems may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors. include, for example, both general and special purpose microprocessors. Generally, a processor receives instructions and data from a read-only memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

Other embodiments are within the scope of the claims.

What is claimed is:

1. An access control system, comprising:
an object detector configured to detect persons present within a detection area;
a token reader configured to interrogate tokens present within a token reader area; and
an access controller configured to receive signals from the object detector and the token reader, and configured to compute one or more characteristics linking persons and tokens based upon signals received from the object detector and the token reader and to determine whether each detected person is carrying a permissioned token based upon the one or more computed characteristics linking persons and tokens.

2. The system of claim 1, wherein the one or more computed characteristics linking persons and tokens correspond to counts of persons and tokens.

3. The system of claim 2, wherein the access controller is configured to tally a count of persons based upon signals received from the object detector and to tally a count of tokens based upon signals received from the token reader.

4. The system of claim 3, wherein the access controller is configured to generate a signal based upon a comparison of the persons count and the tokens count.

5. The system of claim 4, wherein the access controller is configured to generate a signal when the persons count differs from the tokens count.

6. The system of claim 4, wherein the access controller is configured to generate an access granted signal when the persons count is less than or equal to the tokens count.

7. The system of claim 1, wherein the object detector is configured to track one or more persons within the detection area over time.

8. The system of claim 7, wherein the object detector is a vision-based person tracking system.

9. The system of claim 8, wherein the object detector comprises a video system configured to generate depth video streams from radiation received from the detection area, and a processing system configured to detect and track objects based at least in part upon data obtained from the depth video streams.

10. The system of claim 9, wherein the object detector is operable to:
generate a three-dimensional point cloud having members with one or more associated attributes obtained from the time series of video frames and representing selected depth image pixels in a three-dimensional coordinate system spanned by a ground plane and a vertical axis orthogonal to the ground plane;
partition the three-dimensional point cloud into a set of vertically-oriented bins;
map the partitioned three-dimensional point cloud into at least one plan-view image containing for each vertically-oriented bin a corresponding pixel having one or more values computed based upon one or more attributes of the three-dimensional point cloud members occupying the corresponding vertically-oriented bin; and
track the object based at least in part upon the plan-view image.

11. The system of claim 7, wherein movements of detected persons within the detection area are time-stamped.

12. The system of claim 1, wherein the token reader is configured to wirelessly interrogate tokens within the token reader area.

13. The system of claim 1, wherein the one or more computed characteristics linking persons and tokens correspond to measures of separation distance between persons and tokens.

14. The system of claim 11, wherein the access controller is configured to generate a signal when a detected person is separated from a nearest token by a distance measure that exceeds a preselected threshold.

15. An access control method, comprising:
detecting persons present within a detection area;
interrogating tokens present within a token reader area;
computing one or more characteristics linking persons and tokens based upon results of the detecting and interrogating steps; and
determining whether each detected person is carrying a permissioned token based upon the computed characteristics linking persons and tokens.

16. The method of claim 15, wherein the one or more computed characteristics linking persons and tokens correspond to counts of persons and tokens.

17. The method of claim 16, further comprising tallying a count of persons, and tallying a count of tokens.

18. The method of claim 17, further comprising generating a signal based upon a comparison of the persons count and the tokens count.

19. The method of claim 18, further comprising generating a signal when the persons count differs from the tokens count.

20. The method of claim 18, further comprising generating an access granted signal when the persons count is less than or equal to the tokens count.

21. The method of claim 15, further comprising tracking one or more persons within the detection area over time.

22. The method of claim 21, wherein tracking comprises generating depth video streams from radiation received from the detection area, and detecting and tracking objects based at least in part upon data obtained from the depth video streams.

23. The method of claim 22, wherein tracking comprises:
generating a three-dimensional point cloud having members with one or more associated attributes obtained from the time series of video frames and representing selected depth image pixels in a three-dimensional coordinate system spanned by a ground plane and a vertical axis orthogonal to the ground plane;
partitioning the three-dimensional point cloud into a set of vertically-oriented bins;
mapping the partitioned three-dimensional point cloud into at least one plan-view image containing for each vertically-oriented bin a corresponding pixel having one or more values computed based upon one or more attributes of the three-dimensional point cloud members occupying the corresponding vertically-oriented bin; and
tracking the object based at least in part upon the plan-view image.

24. The method of claim 21, further comprising time-stamping movements of detected persons within the detection area.

25. The method of claim 15, wherein the token reader is configured to wirelessly interrogate tokens within the token reader area.

26. The method of claim 15, wherein the one or more computed characteristics linking persons and tokens correspond to measures of separation distance between persons and tokens.

27. The method of claim 26, further comprising generating a signal when a detected person is separated from a nearest token by a distance measure that exceeds a preselected threshold.

28. A machine-readable medium storing machine-readable instructions for causing a machine to:
detect persons present within a detection area;
interrogate tokens present within a token reader area;
compute one or more characteristics linking persons and tokens based upon results of the detecting and interrogating steps; and
determine whether each detected person is carrying a permissioned token based upon the computed characteristics linking persons and tokens.

29. The medium of claim 28, wherein the one or more computed characteristics linking persons and tokens correspond to counts of persons and tokens.

30. The medium of claim 28, wherein the one or more computed characteristics linking persons and tokens correspond to measures of separation distance between persons and tokens.

31. The medium of claim 28, further comprising tracking one or more persons within the detection area over time.

32. The medium of claim 30, wherein tracking comprises generating depth video streams from radiation received from the detection area, and detecting and tracking objects based at least in part upon data obtained from the depth video streams.

33. An access control method, comprising:
visually tracking a person;
determining whether the tracked person has a permissioned token based on one or more characteristics linking persons and tokens; and
generating a signal in response to a determination that the tracked person is free of any permissioned tokens.

34. An access control method, comprising:
detecting tokens crossing a first boundary of a first area;
tallying a count of tokens in the first area based on the tokens detected crossing the first boundary;
detecting persons crossing a second boundary of a second area;
tallying a count of persons in the second area based on the persons detected crossing the second boundary; and
generating a signal in response to a determination that the persons count exceeds the tokens count.

35. The method of claim 34, wherein detecting tokens comprises detecting tokens crossing the first boundary into and out of the first area.

36. The method of claim 35, wherein tallying a count of tokens in the first area comprises subtracting a count of persons crossing the first boundary out of the first area from a count of persons crossing the first boundary into the first area.

37. The method of claim 34, wherein detecting persons comprises detecting persons crossing the second boundary into and out of the second area.

38. The method of claim 37, wherein tallying a count of persons in the second area comprises subtracting a count of persons crossing the second boundary out of the second area from a count of persons crossing the second boundary into the second area.

39. An access control system, comprising:
a token reader configured to detect tokens crossing a first boundary of a first area;
an object detector configured to detect persons crossing a second boundary of a second area; and
an access controller configured to tally a count of tokens in the first area based on the tokens detected crossing the first boundary, tally a count of persons in the second area based on the persons detected crossing the second boundary, and generating a signal in response to a determination that the persons count exceeds the tokens count.

40. A machine-readable medium storing machine-readable instructions for causing a machine to:
detect tokens crossing a first boundary of a first area;
tally a count of tokens in the first area based on the tokens detected crossing the first boundary;
detect persons crossing a second boundary of a second area;
tally a count of persons in the second area based on the persons detected crossing the second boundary; and
generate a signal in response to a determination that the persons count exceeds the tokens count.
